(19) United States
(12) Patent Application Publication
(10) Pub. No.: US 2013/0042315 A1
(43) Pub. Date: Feb. 14, 2013

(54) Client-Client-Server Authentication

(71) Applicants: Jianhui Xie, Redmond, WA (US); Leszek Mazur, Kirkland, WA (US); Sean Daniel, Victoria (CA)

(72) Inventors: Jianhui Xie, Redmond, WA (US); Leszek Mazur, Kirkland, WA (US); Sean Daniel, Victoria (CA)

(73) Assignee: MICROSOFT CORPORATION, Redmond, WA (US)

(21) Appl. No.: 13/207,362

(22) Filed: Aug. 10, 2011

(51) Int. Cl. H04L 9/32; G06F 15/16

(52) U.S. Cl. 726/10

(57) ABSTRACT

Described is a technology by which machines of a (typically small) network have associated public key-based certificates for use in authentication with a server and validation of other machines in the network. This provides an inexpensive and straightforward mechanism to control, manage and maintain client machines, as well as to allow valid client machines to securely communicate with one another and recognize machines that are not valid on the network. Certificates are maintained on the server and checked for validity as needed.

### BACKGROUND

Small computer networks such as found in small businesses or homes typically do not have the facilities of larger networks, e.g., based upon technology such as domains, Active Directory® and so forth. Further, the machines in small networks may run on various platforms, including operating systems from different vendors and/or having different versions, and may be of different types (e.g., laptops, personal computers, smartphones and other devices).

As a result, concepts such as authentication that facilitate control, management, maintenance and the like of the network's machines are not straightforward to implement in a small network. What is desirable is a solution for providing a unified way to authenticate machines as valid and trusted, such as to control, manage and maintain a machine of basically any platform in the local network or Internet, and to facilitate trusted communication between machines.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which certificate technology is used to authenticate client machines on a network, including to allow client machines to securely communicate with one another. In one aspect, an “initiator” client machine that wants to communicate with another “responder” client machine needs to validate the responder client machine, and vice-versa, to provide secure communication. The initiator client and responder client each provide (e.g., separately) each provide each other's certificate to a server. The server determines (e.g., by a lookup) whether each certificate is valid and returns a response to each. If the initiator knows that the responder's certificate is valid, and vice-versa, they may establish a secure communication session.

In one implementation, the server maintains an instance of the initiator certificate and an instance of the responder certificate, (along with any other client certificates). Each certificate associated with a client machine includes a public key that corresponds to a private key maintained at that client device. The server also maintains property data associated with each certificate, e.g., located by using the public key as a search key to the index.

In one aspect, the private key is generated when a machine initially couples to the network, with the certificate including the public key created based upon instructions of an administrator with appropriate credentials. In this way, only a machine that the administrator desires to add to the network has a valid certificate in the network. An administrator may revoke and un-revoke a certificate as desired.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a network in which certificates are used for authentication of the network machines.

FIG. 2 is a flow diagram representing example steps that may be taken when coupling a new machine to a network to facilitate authentication.

FIG. 3 is a flow diagram representing example steps that may be taken to validate machines for client-to-client communication, including using server-based authentication.

FIG. 4 is a block diagram representing an exemplary computing environment into which aspects of the subject matter described herein may be incorporated.

### DETAILED DESCRIPTION

Various aspects of the technology described herein are generally directed towards an authentication/validation technology useful in a small network, in which a server maintains certificate data and property information for each valid client machine. The client machines each use private-public key technology to authenticate with the server, and to communicate with the server, including checking received certificate data so that each client device knows whether another client device is valid. As will be understood, the technology described herein thus provides a platform-independent way to facilitate control, management and maintenance of network machine, as well as authenticated (secure/trusted) communication between any client machines.

Using certificate authentication, a unique certificate (e.g., including a GUID) is deployed to a client machine on a local network or the Internet. When one client machine communicates with any other client machine, the certificate is used to identify the clients to each other, creating mutual security between the machines. As can be readily appreciated, with this technology, centralization for viewing, patching, controlling, backup, file restore and bare metal restore the client cross the network and operating system platform may be securely employed. Using certificate authentication, communication for management or general communication between clients or server to client or client to server may be maintained independent of which operating system is running on a given client, and/or regardless where the client is based (e.g., local network or Internet). The server on the network offers a root certificate to the clients to which the server connects, which are available for connection both locally and on the Internet to validate the authenticity of the certificate for mutual authentication.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in data communications in general.

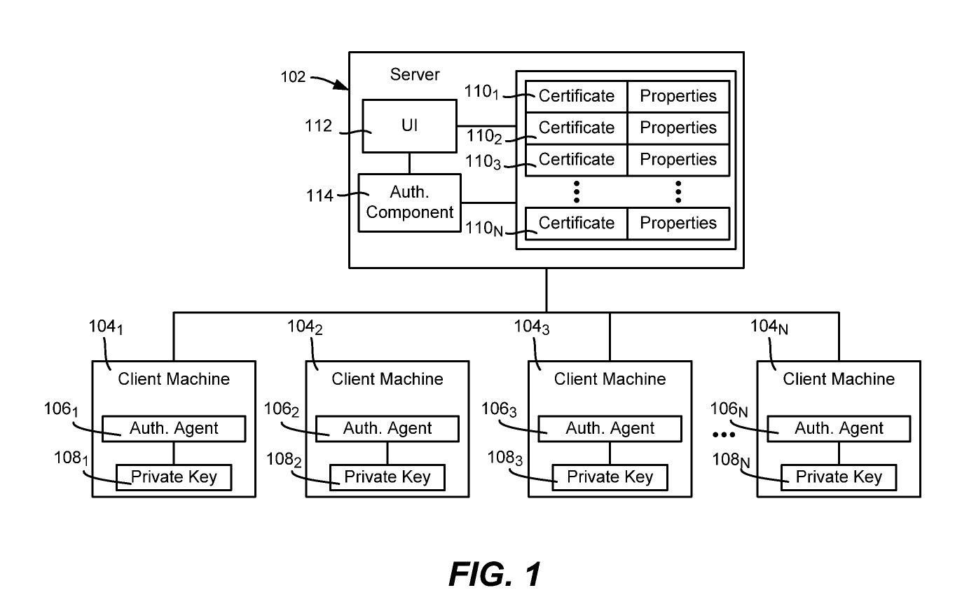

FIG. 1 shows a block diagram in which a server 102 is coupled to a plurality of client machines 104₁-104ₙ. The client machines 104₁-104ₙ may be connected through a local area network connection or an internet connection. The client machines 104₁-104ₙ may be individually based upon any suitable platform including the same and/or different operating system vendors and/or versions, and may be different types of machines, such as personal computers, smartphones, game consoles and the like.

The server 102 may comprise one or more machines (physical or virtual), and a single physical machine may be configured to contain the server (or part thereof) as well as one more client machines, e.g., via virtual machine technology. The server 102 or any part thereof may be implemented remotely, e.g., as a “cloud” server or part of a “cloud” service.

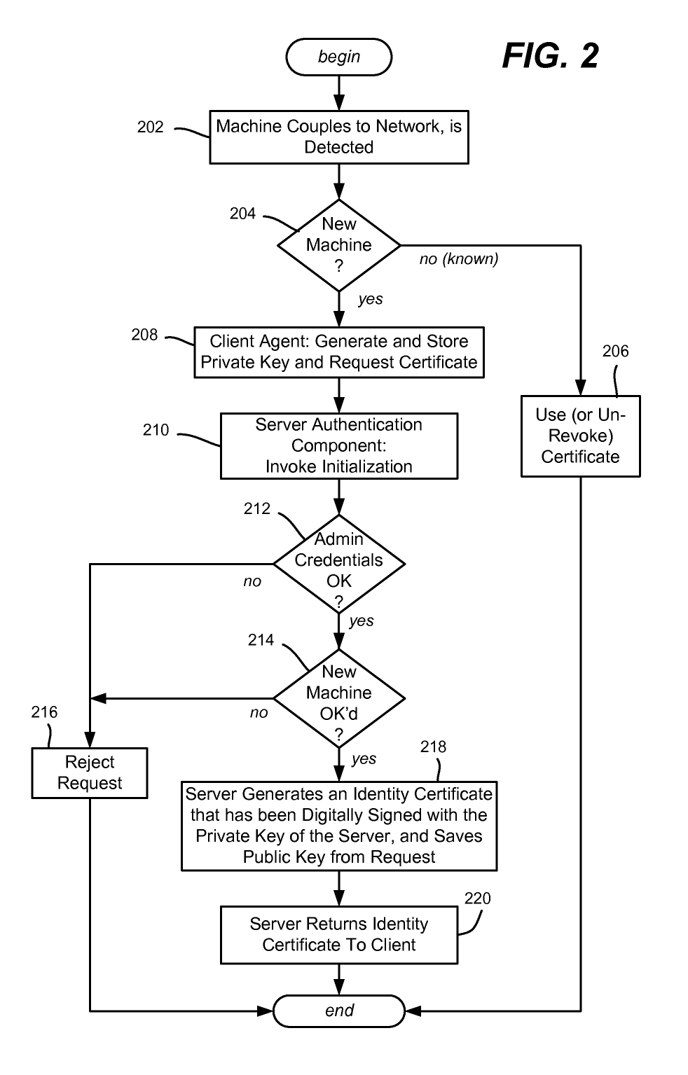

As generally represented in the example steps of FIG. 2, when each client machine is attached to the network, at steps 202 and 204 the machine is detected by a service or the like, e.g., running on the server. Any machine is detected, including one that is determined to be a new machine that is not valid on the network. Note that if recognized as an existing machine via a valid certificate, at step 206 its certificate may be used for authentication if valid, or if revoked (as described below), may be un-revoked as decided by an administrator.

As represented via step 208, a client agent running on the new machine (e.g., authentication agent 106₁) generates and stores a private key 108₁ (e.g., comprising a GUID), and requests a certificate from the network server 102 based upon the client's corresponding public key provided in association with the request. At generally the same time, in response to detection of a new machine, at step 210 the service provides an administrator with a user interface 112 that allows the administrator to provide administrator credentials and specify that the machine is valid on the network (or reject it as not valid as decided by the administrator). For example, the service may use an authentication component 114 that includes the user interface 112. The administrator thus may be interacting with the server 102 directly, (or possibly through a valid client machine's remote server connection or the like), e.g., via a console or pop-up user interface included in the authentication component 114, which indicates that a new machine has been attached and is requesting validation. The administrator alternatively may be operating on the new client machine (e.g., 104₁), in which event an initialization program (e.g., part of the authentication agent 106₁) may be used in conjunction with the server authentication component 114 to verify the administrator's credentials with the server.

As represented via step 212, administrator credentials are checked such that rogue users are rejected, thus preventing a malicious user or the like from joining a machine to the network simply by wirelessly (or even via wired) coupling a machine to the network. At step 214, the administrator may also reject (step 216) a request to join; (typically in a small network the administrator will be adding the new machine personally or by close personal communication with the person doing so, and will know when a proper machine is being added).

As described above with respect to step 208, as part of initialization, the client machine generates a private key (e.g., a GUID) and maintains it locally. A corresponding public key (e.g., a GUID) is maintained on the server 102, where in one implementation the server 102 includes the public key within an instance of a certificate (e.g., 110₁, FIG. 1) associated with that client machine 104₁ (steps 218 and 220). The private and public keys may thereafter be used in a standard transport layer security (TLS) handshake operation for authentication of that client machine.

In one implementation, the certificate comprises the public key along with a user-friendly machine name (e.g., in human-readable text), which provides a number of benefits. As one benefit, if a client machine is replaced with another (e.g., to upgrade it), the previous user-friendly machine name may be reused, which other users and other components may then recognize without necessarily even noticing the replacement. Alternatively, if a machine is simply renamed, the private and public keys remain the same, and authentication may proceed as normal. The public key GUID may be used as the index key to find the certificates and other associated properties.

In one aspect, when a machine is no longer valid, the certificate may be revoked by marking the certificate as invalid (rather than deleting the certificate). For example, if a Smartphone or laptop is lost, the administrator may mark the certificate as invalid (e.g., in a property that the server checks before taking further action). If the Smartphone or laptop is later found, when re-coupled to the network the administrator may mark the certificate as valid (un-revoke the certificate marked as revoked), whereby the Smartphone or laptop operates as before.

Once the server has established a certificate for the client, the client and server may authenticate via known certificate (public key, private key) technology. For example, a standard challenge-response protocol may be used. This allows the server to control, manage and maintain the client.

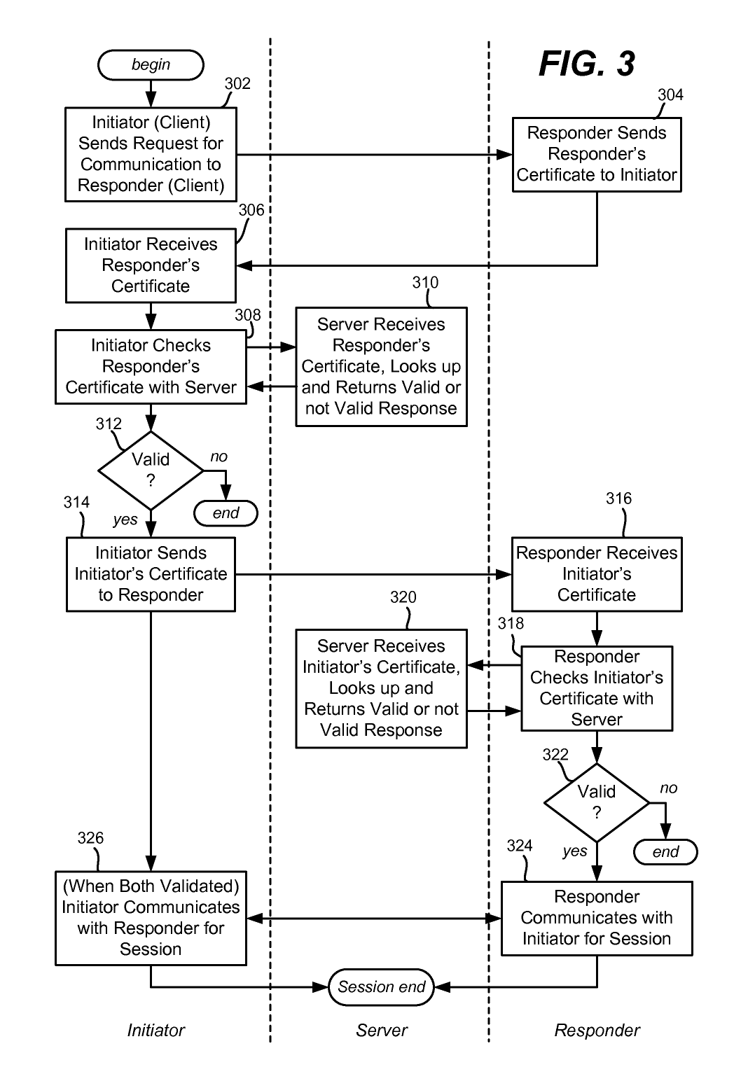

Further, the clients may now validate one another for client-client communication, as described below. More particularly, turning to client-client authentication aspects, FIG. 3 shows general operations when one client wants to communicate with another client. As used herein for clarity, the client that wants to start communication is referred to herein as an “initiator client” (or more simply the “initiator”), with the other communicating client referred to as a “responder client” (or more simply the “responder”). In FIG. 3, example operations of the initiator client are shown to the left, example operations of the server in the center, and example operations of the responder client to the right of the flow diagram. For purposes of simplicity, it is assumed that the initiator, server and responder are all are properly connected and running their respective authentication component/agents, and thus capable of communication with one another.

In one implementation, the initiator sends a request for communication to the responder, as represented by step 302. Note that in an alternative implementation, the request for communication may include the initiator's certificate, however in the example of FIG. 3 the initiator's certificate is not sent at this time.

At step 304, the responder returns the responder's certificate in response to the request. Receipt of the responder's certificate is represented at step 306.

As represented via steps 308 and 310, the initiator and server communicate to check the validity of the responder's certificate; note that the initiator may need to first authenticate with the server to start an initiator-server session. If the certificate is validated (step 312), the process continues as described below, otherwise the process ends.

If the responder's certificate was valid, step 314 starts what is basically a counterpart validation process for the initiator's certificate, by having the initiator send the initiator's certificate to the responder. Step 316 represents receiving the initiator's certificate, with steps 318 and 320 validating the initiator's certificate with the server (after server authentication of the responder if needed). Note that in the above-described alternative implementation in which the initiator sends the initiator's certificate to the responder as part of the initial request to communicate, these steps may be performed prior to the initial response back providing the requestor's certificate (assuming the initiator is validated).

If valid (step 322), the responder and initiator know that each machine is valid on the network, may then securely communicate with one another as represented via steps 324 and 326. Note that in one implementation, validation/communication is per session, e.g., corresponding to a TCP connection.

As can be seen there is provided a certificate-based technology for client to server authentication and client-to-client authentication via the server. While suitable for small networks, the technology remains compatible with large network technology. For example, the certificate-based authentication technology may work outside of Active Directory® or inside of Active Directory®.

### Exemplary Operating Environment

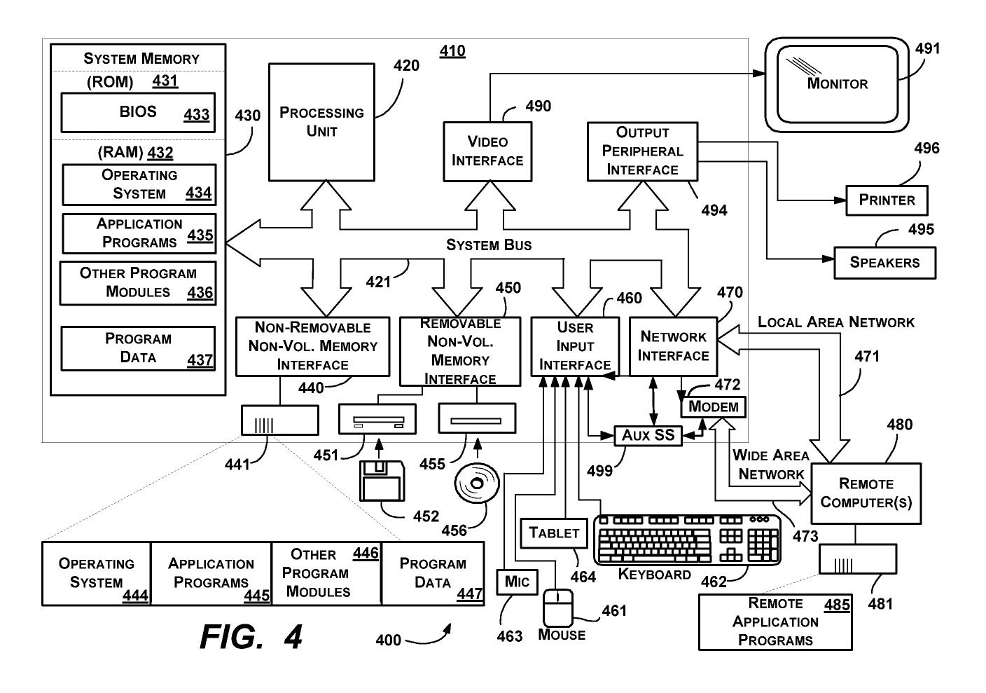

FIG. 4 illustrates an example of a suitable computing and networking environment 400 into which the examples and implementations of any of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor comprising, validating a responder client machine at an initiator client machine coupled to the responder client machine via a network connection, including communicating to receive a responder certificate from the responder client machine, and communicating with a server to determine whether the responder certificate is valid.

2. The method of claim 1 further comprising, at the responder client machine, validating the initiator client machine, including communicating to receive an initiator certificate from the initiator client machine, and communicating with the server to determine whether the initiator certificate is valid.

3. The method of claim 2 further comprising, securely communicating between the initiator client machine and the responder client machine using the initiator certificate and the responder certificate.

4. The method of claim 1 further comprising, maintaining an instance of the initiator certificate and an instance of the responder certificate at the server, maintaining an initiator private key at the initiator client machine that corresponds to a public key included in the initiator certificate maintained at the server, and maintaining a responder private key at the responder client machine that corresponds to a public key included in the responder certificate maintained at the server.

5. The method of claim 4 further comprising, maintaining initiator property data associated with the instance of the initiator certificate, and maintaining responder property data associated with the instance of the responder certificate.

6. The method of claim 5 further comprising, using the public key of the initiator certificate as an index key to locate the property data associated with the instance of the initiator certificate.

7. The method of claim 4 further comprising, detecting an initial coupling of the initiator machine to the network, generating the private key at the initiator machine, and creating the initiator certificate at the server.

8. The method of claim 1 further comprising, revoking the initiator certificate by marking the initiator certificate as invalid.

9. The method of claim 7 further comprising, un-revoking the revoked initiator certificate by marking the initiator certificate as valid.

10. In a networked machine environment, a system comprising, a server configured to maintain certificate data for a plurality of client machines that are valid in the network, the server configured to access the certificate data to determine whether a certificate associated with the request is valid in the network.

11. The system of claim 10 wherein the server is configured to access the certificate data to respond to a request from a first client machine in the network as to whether the certificate, which corresponds to a second client machine, is valid.

12. The system of claim 11 wherein the first client machine and second client machine have different platforms.

13. The system of claim 11 wherein the first client machine comprises a personal computer and the second client machine comprises a Smartphone.

14. The system of claim 11 wherein the server validates a first certificate provided by a second client machine and validates a second certificate provided by a first client machine to facilitate secure communication between the first client machine and the second client machine.

15. The system of claim 10 wherein the certificate data associated with a client machine includes public key data corresponding to private key data of the client machine, and name data of the client machine.

16. The system of claim 10 wherein the server is configured to access the certificate data to control, manage or maintain, or any combination of control, manage or maintain, at least one of the plurality of client machines.

17. One or more computer-readable media having computer-executable instructions, which when executed perform steps, comprising:
receiving a responder certificate as part of a request from an initiator client machine of a network;
determining whether the responder certificate is valid, and returning a response to the request from the initiator client machine that indicates whether the responder certificate is valid;
receiving an initiator certificate as part of a request from a responder client machine of the network; and
determining whether the initiator certificate is valid, and returning a response to the request from the responder client machine that indicates whether the initiator certificate is valid.

18. The one or more computer-readable media of claim 16 having further computer-executable instructions comprising, detecting a new machine coupled to the network, receiving instructions from an administrator to add the new machine as a valid machine to the network, and creating a certificate for the new machine by which the new machine is able to authenticate with a server of the network.

19. The one or more computer-readable media of claim 16 having further computer-executable instructions comprising, receiving instructions from an administrator to revoke a certificate for a specified machine on the network, and revoking the certificate for the specified machine by associating information with the certificate that marks the certificate as invalid.

20. The one or more computer-readable media of claim 16 having further computer-executable instructions comprising using the initiator certificate or the responder certificate, or both, for viewing, patching, controlling, backing up, file restoring and bare metal restoring of at least one client on the network.
